(19) United States
(12) Patent Application Publication
(10) Pub. No.: US 2008/0234951 A1
(43) Pub. Date: Sep. 25, 2008

(54) Gravity Flowmeter for Materials Analysis

(75) Inventor: Sang-Soo Kim, Athens, OH (US)

Correspondence Address: CALFEE HALTER & GRISWOLD, LLP, 800 SUPERIOR AVENUE, SUITE 1400, CLEVELAND, OH, 44114, US

(73) Assignee: OHIO UNIVERSITY, Athens, OH (US)

(21) Appl. No.: 11/994,569

(22) PCT Filed: Jul. 5, 2006
(86) PCT No.: PCT/US2006/026193

§ 371 Date: Jun. 3, 2008

Related U.S. Application Data
(60) Provisional application No. 60/696,643, filed on Jul. 5, 2005.

(51) Int. Cl. G01N 11/00; G01F 1/00; G01N 25/16

(52) U.S. Cl. 702/52; 702/47; 374/55; 374/E05.001

(57) ABSTRACT

Properties of asphalt are determined by determining an expansion of a plurality of samples of the asphalt as a function of current dimensions of the respective samples, determining a creep of the samples as a function of the current dimensions of the respective samples, repeating the determining steps over a plurality of temperatures, and determining a master creep modulus and a temperature coefficient of the asphalt as a function of the plurality of expansions and the plurality of creeps.

This application claims the benefit of U.S. Provisional Application No. 60/696,643, filed Jul. 5, 2005, which is hereby incorporated by reference.

### BACKGROUND

The present invention relates to determining properties of asphalt. It finds particular application in conjunction with determining a coefficient of thermal expansion, a master creep modulus, and a temperature shift function and will be described with particular reference thereto. It will be appreciated, however, that the invention is also amenable to other applications.

The task of determining viscoelastic properties of materials (including asphalt binder and polymers) is routinely performed for product development and product performance evaluation. To have complete rheological spectrum over a wide range of temperatures and loading rates, many tests at different temperatures and loading rates are performed. Therefore, the number of required tests, the task of determining viscoelastic properties of materials is labor intensive expensive. As a result, many tests for quality control/quality assurance (QC/QA) are not completed. In some cases, such lack of QC/QA testing results in unsatisfactory performance of viscoelastic materials.

Coefficient of thermal expansion (CTE) is a parameter used for determining thermal stress development within asphalt pavement. However, there is currently no easy to use reliable method for testing CTE. Even though a dilatometric method has been used to study CTE of asphalt binders, its complex test procedure prohibited a routine use of this method.

The present invention provides a new and improved method and apparatus which addresses the above-referenced problems.

### SUMMARY

In one aspect of the present invention, it is contemplated to determine properties of asphalt by determining an expansion of a plurality of samples of the asphalt as a function of current dimensions of the respective samples, determine a creep of the samples as a function of the current dimensions of the respective samples, repeat the determining steps over a plurality of temperatures, and determine a master creep modulus and a temperature coefficient of the asphalt as a function of the plurality of expansions and the plurality of creeps.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a system in accordance with one embodiment of an apparatus illustrating principles of the present invention;

FIG. 2 illustrates an exemplary methodology in accordance with one embodiment illustrating principles of the present invention;

FIG. 3 illustrates an example of a master creep stiffness curve;

FIG. 4 illustrates simulated responses in accordance with one embodiment of the present invention;

FIG. 5 illustrates predicted versus measured master creep curves;

FIG. 6 illustrates a master creep curve as a function of reduced time; and

FIG. 7 illustrates thermal stress development calculated using true values and derived parameters in accordance with one embodiment of the present invention.

### DETAILED DESCRIPTION OF ILLUSTRATED EMBODIMENT

Analysis of low temperature thermal cracking behavior of an asphalt binder requires rheological and thermal properties as inputs. Just as all other viscoelastic materials, the response of an asphalt binder to an applied load is loading rate and temperature dependent. A master modulus curve and shift factor function characterize these rate and time dependencies, respectively. The construction of a reliable master curve and shift factor function is time consuming and labor intensive, which requires repeating many isothermal rheological tests (such as creep test, uniaxial compression test, or direct tension test) at several temperatures. A prediction for the thermal stress development in an asphalt and an asphalt mixture require accurate coefficients of thermal expansion/contraction (CTE) values.

The test device, test procedure, and/or analysis software presented herein are used to determine three (3) properties of an asphalt binder from a single temperature swipe (from about −60° C. to about 25° C.) of five (5) asphalt binder specimens. More specifically, the three (3) properties determined by the test device, test procedure, and/or analysis software include: 1) master creep stiffness curve; 2) shift factor function; and 3) CTE.

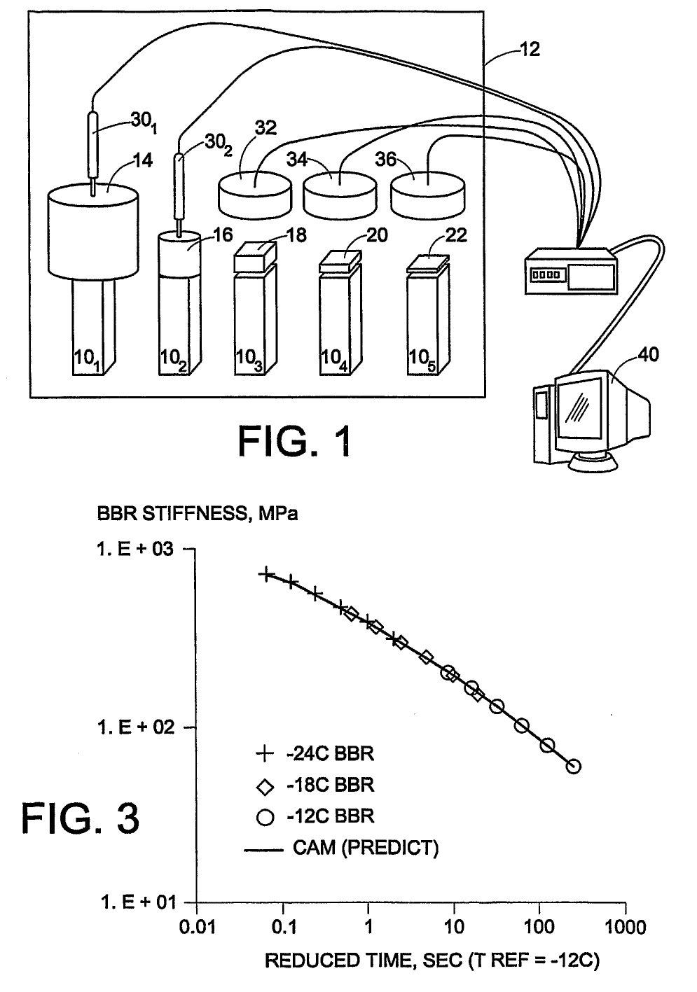

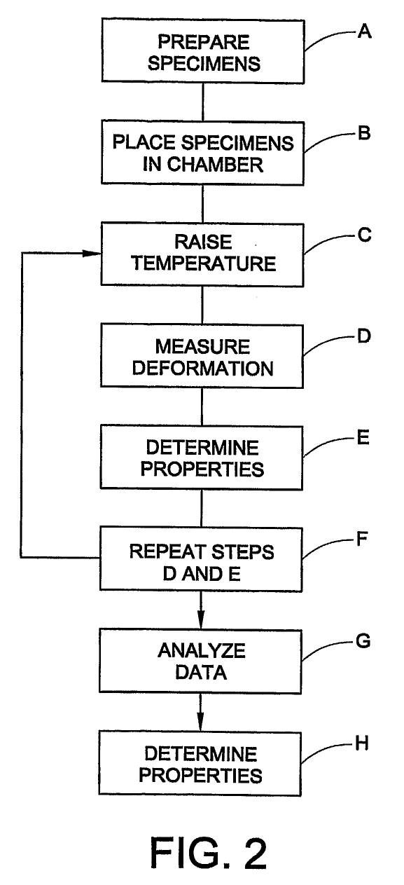

With reference to FIGS. 1 and 2, specimens are prepared in a step A. In the illustrated embodiment, five (5) specimens 10₁, 10₂, 10₃, 10₄, 10₅ are prepared. In one embodiment, each of the specimens 10₁, 10₂, 10₃, 10₄, 10₅ is molded to have dimensions of about 25.4 mm (height)×about 12.7 mm (width)×12.7 mm (depth). In a step B, each of the specimens 10₁, 10₂, 10₃, 10₄, 10₅ is placed inside an environmental chamber 12 having a temperature of about −60° C.

In a step C, a mass 14 of about 10.0 kg is placed on top of the first specimen 10₁. A mass 16 of about 1.0 kg is placed on top of the second specimen 10₂. A mass 18 of about 0.1 kg is placed on top of the third specimen 10₃. In one embodiment, the masses 14, 16, 18 are stainless steel. Plates 20, 22 are molded together with the specimens 10₄, 10₅. In one embodiment, the plates 20, 22 are copper and have the same cross-sectional dimensions (e.g., 12.7 mm×12.7 mm) as the specimens 10₄, 10₅.

Dimensional changes of the specimens 10₁, 10₂ due to temperature changes are measured using, for example, linear variable displacement transducers (LVDT) 30₁, 30₂. Dimensional changes of the specimens 10₃, 10₄, 10₅ due to temperature changes are measured using, for example, using non-contact capacitive sensors 32, 34, 36. Non-contact capacitive sensors are used for measuring the dimensional changes of the specimens 10₃, 10₄, 10₅ instead of LVDT's because the small force created by the contact of LVDT's on the specimens 10₃, 10₄, 10₅ would cause significant effects on the load response at ambient to high temperatures. All of the sensors 30₁, 30₂, 32, 34, 36 are calibrated for temperature change.

In a step C, the temperature of the chamber 12 is raised a first increment (e.g., about 10° C.) over a period of time (e.g., one (1) hour). In one embodiment, the temperature of the chamber 12 is raised from about −60° C. to about 25° C. in increments of about 10° C. per hour.

In a step D, the deformation (e.g., dimension) of each of the specimens 10₁, 10₂, 10₃, 10₄, 10₅ is measured and recorded on, for example, a computing device 40. It is to be understood that the calibrated deformation of the masses 14, 16, 18 and plates 20, 22 are subtracted from the actual measurements. Expansion and creep are determined as a function of the dimension in a step E. In one embodiment, software is used to determine the CTE, creep stiffness, and shift factor.

The measurement and determination steps D, E are repeated in a step F every predetermined time period (e.g., every 10 seconds) until the temperature of the chamber 12 is raised (e.g., after one (1) hour) by returning to the step C. After enough cycles have been measured and the temperature has been raised to about 25° C., control passes to a step G for analyzing the data. The coefficient of thermal expansion, a master creep modulus, and temperature shift function are determined in a step H as a function of the data analyzed in the step G.

When the temperature is raised from about −60° C. to about 25° C., deformation of each asphalt binder being tested is governed by two (2) mechanisms (e.g., upward thermal expansion and downward creep). Thermals strain:

εₜₕ=ΔT·α (constant α) or

$${ɛ}_{th} ( T ) = {\int }_{- 60}^{T} α ( {T}^{′} ) d {T}^{′}$$

(a varies with temperature)

Where,
ΔT=temperature change
α=thermal expansion coefficient of asphalt binder

Isothermal creep strain:

ε_{creep}(t)=σ/S(t)

Where,
σ=constant stress due to applied load and weight of asphalt binder
S(t)=creep stiffness of asphalt binder at time t

For the transient temperature condition, the creep strain can be obtained using the time-temperature superposition principle where the effect of time duration at one temperature can be expressed by a different time duration at another temperature for the same effect. This relationship is expressed by the temperature dependent shift factor function a_{T}(T). When time durations at all other temperatures are transformed into a time scale at a single temperature (reference temperature, Tₒ), it is called reduced time. Then, the creep strain at a reduced time, τ, is given as:

ε_{creep}(τ)=σ/S(τ)

Where,
σ=stress due to applied load and weight of asphalt binder
S(τ)=creep stiffness of asphalt binder at reduced time τ
τ=reduced time at temperature T (summation of all reduced time between current T and initial temperature −60° C.)=

$${\int }_{- 60}^{T} \frac{( dt / DT )}{{a}_{T} ( T )} d T$$

(dt/DT)=inverse of heating rate

a_{T}(T)=shift factor as a function of T

Total strain of heating experiment at temperature T is simple addition of these two (2) strains.

ε_{Total}(T)=εₜₕ(T)+ε_{creep}(T)

It should be noted that ε_{creep}(T) cannot be expressed in terms of reduced time, τ, until the shift function is determined.

At low temperatures with slow loading and small strain, the stress-strain (or load-deformation relationship is linear; strain (o deformation) is proportional to applied stress (or load). By simple algebra, the total strain of each sample can be separated into εₜₕ(T) and ε_{creep}(T). Then, CTE of asphalt binder is determined as:

α(T)=dεₜₕ(T)/dT

A numerical solution for converting ε_{creep}(T) to ε_{creep}(τ) is obtained suing master curve and shift factor equations. Master creep curves of asphalt binders have been successfully described by several empirical models. One such model is the Christensen-Anderson-Marasteanu (CAM) model, which describes the master creep stiffness modulus of asphalt in forms of:

S(τ)=S_{glassy}[1+(τ/λ)^{β}]^{-κ/β}

where,
S(τ)=stiffness at reduced time, τ
S_{glassy}=glassy modulus of asphalt; constant (3 GPa)
τ=reduced time=t/a_{T}(t)
a_{T}(t)=time-temperature shift factor
λ, β, κ=CAM model constants for best fit

An example of the master creep curve constructed by manual shifting and comparison with the CAM model are shown in FIG. 3. The CAM model fits the experimental data very well.

The temperature dependency of the shift factors is commonly modeled using the Arrhenius equation for below the glass transition temperatures and WLF equation for above the glass transition temperatures. The Arrhenius equation is more appropriate for the data:

ln(a_{T}(T))=a₁(1/T−1/T_{ref})

Where,
a_{T}=time temperature shift factor
a₁=asphalt dependent constant
T=temperature
T_{ref}=reference temperature

A numeric solution is found by an optimization program; determining λ, β, κ, and a₁ that minimize the differences between measured ε_{creep}(T) and predicted ε_{creep}(T) by theory.

### Example

Simulated data is used for this example. The total deformation of five (5) specimens for a −60° C. to 10° C. swipe were calculated based on the linear viscoelasticity theory using an experimentally determined master creep curve and a shift factor function of an asphalt binder (FHWA B6227). A temperature dependent CTE, α(T), for a binder with the similar low temperature characteristics was found in the literature and was used for this example. The total stress on each of the specimens is given in Table 1 and parameters for rheological and thermal properties are given in Table 2.

TABLE 1
Stress acting on the specimens

| | Specimen | Specimen | Specimen | Specimen | Specimen |
|---|---|---|---|---|---|
| | #1 | #2 | #3 | #4 | #5 |
| Mass | 10 kg | 1 kg | 100 g | 10 g | 1 g |
| for metal | 607601.0 | 60760.1 | 6076.0 | 607.6 | 60.8 |
| weight, Pa | | | | | |
| for sample | 124.5 | 124.5 | 124.5 | 124.5 | 124.5 |
| weight, Pa | | | | | |
| Total Stress, | 607725.5 | 60884.6 | 6200.5 | 732.1 | 185.2 |
| Pa | | | | | |

TABLE 2
True parameters

| | | | | α(T) | | | |
|---|---|---|---|---|---|---|---|
| CAM Model | | | a_{T}(T) | Tg, | | α_{g}, | αₗ, |
| λ | β | κ | a1 | (1/° C.) | R | (1/° C.) | (1/° C.) |
| 14.5 | 0.158 | 0.668 | 28684 | −28.2 | 6.21 | 1.16E−04 | 1.96E−04 |

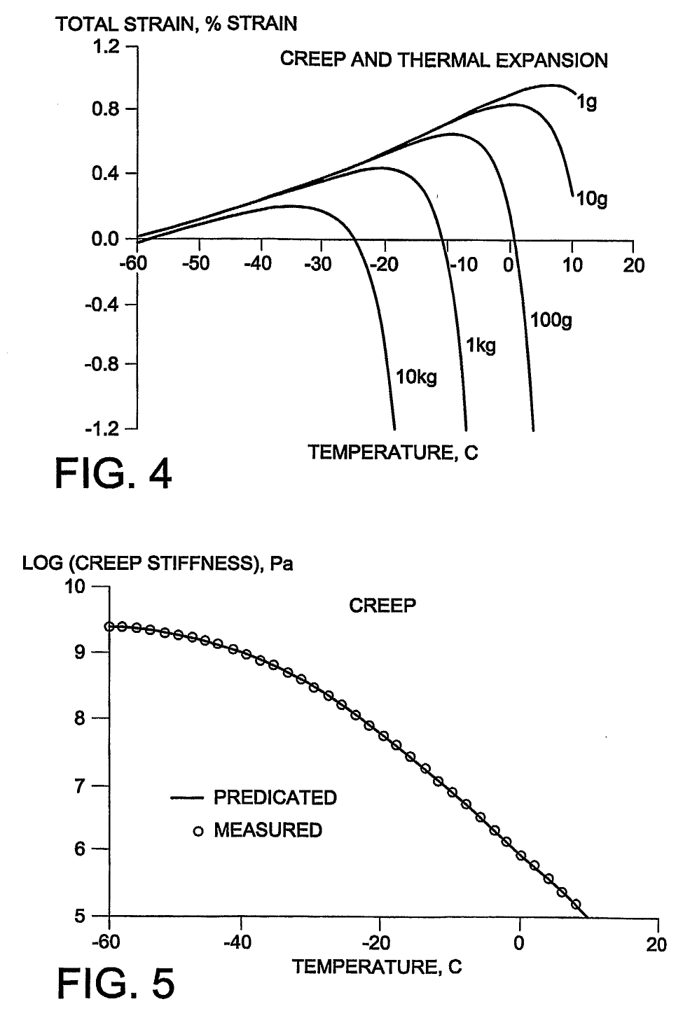

When the test performed on the data, the strain curves illustrated in FIG. 4 are expected to be developed. The viscoelastic theory used for this prediction is known to be very accurate for data testing conditions until a very high strain at elevated temperatures is reached.

The difference between 10 kg strain and 1 kg strain is:

$${{ɛ}_{total} ( T )}_{10 kg} - {{ɛ}_{total} ( T )}_{1 kg} = [ {{ɛ}_{th} ( T )}_{10 kg} + {{ɛ}_{creep} ( T )}_{10 kg} ] - [ {{ɛ}_{th} ( T )}_{1 kg} + {{ɛ}_{creep} ( T )}_{1 kg} ] = [ {\int }_{- 60}^{T} α ( {T}^{′} ) d {T}^{′} + {σ}_{10 kg} / S ( T ) ] - [ {\int }_{- 60}^{T} α ( {T}^{′} ) d {T}^{′} + {σ}_{1 kg} / S ( T ) ] = {σ}_{10 kg} / S ( T ) - {σ}_{1 kg} / S ( T ) = {σ}_{9 kg} / S ( T ) \\ ( creep strain for 9 kg mass )$$

Rearrange the equation for S(T):

S(T)=σ_{9kg}/[εₜₒₜₐₗ(T)_{10kg}−εₜₒₜₐₗ(T)_{1kg}]

This equation provides a good estimate for a temperature range between about −60° C. to about 25° C. The process is repeated to obtain S(T) for other temperature regions (for example, strains from specimens #2 and #3 for about −25° C. to about −5° C. range, and so on). The combined creep curve (circles labeled as ‘measured’) for the entire temperature range is given in FIG. 5.

An optimization software is developed to fit the combined creep curve as a function of test time and temperature with a theoretical creep curve derived from CAM model and Arrhenius equation. The software determines a set of CAM parameters and a₁ fitting the measured data best. The results of the converging process is shown in Table 3.

TABLE 3
Converging process.

| Iteration | λ | β | κ | a1 | SSE |
|---|---|---|---|---|---|
| 1 | 20.1 | 0.170 | 0.706 | 26760 | 0.000667 |
| 2 | 18.6 | 0.168 | 0.700 | 27146 | 0.000177 |
| 3 | 19.3 | 0.170 | 0.705 | 26789 | 0.000439 |
| 4 | 15.4 | 0.166 | 0.685 | 27630 | 0.000360 |
| 5 | 18.3 | 0.166 | 0.694 | 27358 | 0.000362 |
| 6 | 18.4 | 0.166 | 0.695 | 27399 | 0.000123 |
| 7 | 18.4 | 0.167 | 0.696 | 27330 | 8.75E−05 |
| 8 | 18.5 | 0.168 | 0.698 | 27190 | 0.000119 |
| 9 | 18.3 | 0.167 | 0.697 | 27290 | 0.000104 |
| 10 | 18.4 | 0.167 | 0.697 | 27265 | 9.18E−05 |
| 11 | 18.5 | 0.167 | 0.697 | 27274 | 7.92E−05 |
| 12 | 18.4 | 0.167 | 0.697 | 27275 | 8.14E−05 |
| 13 | 18.5 | 0.167 | 0.697 | 27276 | 7.71E−05 |
| 14 | 18.5 | 0.167 | 0.697 | 27276 | 7.74E−05 |
| 15 | 18.5 | 0.167 | 0.697 | 27275 | 7.71E−05 |
| 16 | 18.5 | 0.167 | 0.697 | 27276 | 7.71E−05 |
| 17 | 18.5 | 0.167 | 0.697 | 27275 | 7.70E−05 |
| 18 | 18.5 | 0.167 | 0.697 | 27275 | 7.70E−05 |

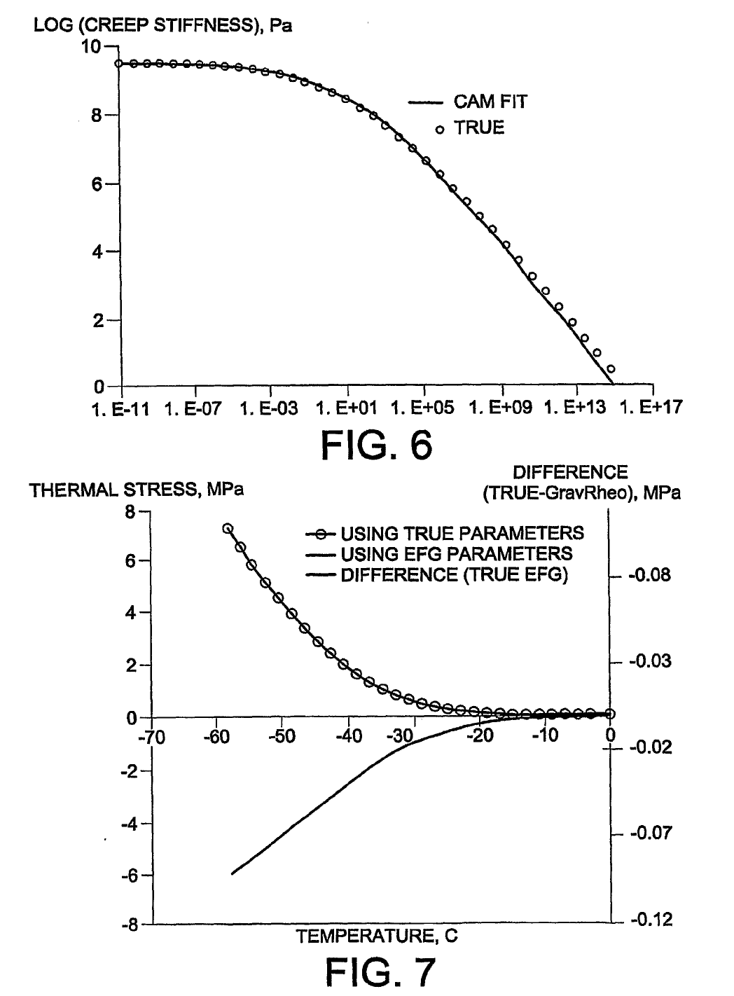

Each iteration performs calculations for 1000 combinations of four (4) parameters and chooses the best set. After 13 iterations the SSE (sum of square error) of log stiffness converged to a minimum. The creep curve predicted by this optimization software is also plotted in FIG. 5 (solid line). The CAM parameters and shift factor constant determined by this process is giving in Table 4. The master creep curve as a function of reduced time is illustrated in FIG. 6.

TABLE 4
CAM parameters and shift factor constant; true vs. predicted

| | CAM Model | | | a_{T}(T) | α(T) | | | |
|---|---|---|---|---|---|---|---|---|
| Parameter | λ | β | κ | a1 | Tg, (1/° C.) | R | α_{g}, (1/° C.) | αₗ, (1/° C.) |
| True | 14.5 | 0.158 | 0.668 | 28684 | −28.2 | 6.21 | 1.16E−04 | 1.96E−04 |
| Predicted | 18.5 | 0.167 | 0.697 | 27275 | — | — | — | — |

Thermal strain is obtained from one more step of simple algebra:

$${ɛ}_{th} ( T ) = {{ɛ}_{th} ( T )}_{10 kg} = … = {{ɛ}_{th} ( T )}_{1 g} = {{ɛ}_{total} ( T )}_{10 kg} - {σ}_{9 kg} / S ( T ) ( 10 / 9 ) = {{ɛ}_{total} ( T )}_{10 kg} - [ {{ɛ}_{total} ( T )}_{10 kg} - {{ɛ}_{total} ( T )}_{1 kg} ] ( 10 / 9 )$$

Repeating the process for a different temperature range provides one continuous CTE versus temperature. Because this simulation does not include error terms, the same parameters for CTE would be obtained.

One of the utility of rheological and thermal characterization is to evaluate thermal stress development within asphalt when contraction is prevented. Thermal stress of the asphalt tested were calculated with both sets of parameters (true and predicted) and they agree as well as illustrated in FIG. 7.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A method for determining properties of asphalt, the method comprising:
determining an expansion of a plurality of samples of the asphalt as a function of current dimensions of the respective samples;
determining a creep of the samples as a function of the current dimensions of the respective samples;
repeating the determining steps over a plurality of temperatures; and
determining a master creep modulus and a temperature coefficient of the asphalt as a function of the plurality of expansions and the plurality of creeps.

2. The method for determining properties of asphalt as set forth in claim 1, wherein the steps of determining the expansion and creep are repeated every 10 seconds over the plurality of temperatures.

3. The method for determining properties of asphalt as set forth in claim 2, further including:
raising the temperature about 10° C. every hour.

4. The method for determining properties of asphalt as set forth in claim 1, further including:
determining a coefficient of thermal expansion of the asphalt.

5. The method for determining properties of asphalt as set forth in claim 4, wherein the coefficient of thermal expansion is determined as α(T)=dεₜₕ(T)/dT.

6. The method for determining properties of asphalt as set forth in claim 1, further including:
measuring the dimensions of the samples.

7. The method for determining properties of asphalt as set forth in claim 6, wherein the measuring includes:
measuring the dimensions of the samples via linear variable displacement transducers.

8. The method for determining properties of asphalt as set forth in claim 7, wherein the measuring includes:
measuring the dimensions of the samples via capacitive sensors.

9. A system for determining properties of asphalt, the method comprising:
a chamber, a temperature in the chamber being varied as a function of time;
a plurality of samples of the asphalt in the chamber;
a plurality of respective measuring devices for measuring changing dimensions of the asphalt as the temperature in the chamber changes;
a memory device for storing a plurality of the dimensions;
a computing device for determining an expansion of a plurality of samples of the asphalt as a function of current dimensions of the respective samples, determining a creep of the samples as a function of the current dimensions of the respective samples, and determining a master creep modulus and a temperature coefficient of the asphalt as a function of the plurality of expansions and the plurality of creeps.

10. The system for determining properties of asphalt as set forth in claim 9, wherein the measuring devices include:
linear variable displacement transducers.

11. The system for determining properties of asphalt as set forth in claim 10, wherein the measuring devices include:
capacitive sensors.

12. The system for determining properties of asphalt as set forth in claim 9, wherein the computing device controls the temperature to raise in the chamber by about 10° C. every hour.

13. The system for determining properties of asphalt as set forth in claim 9, wherein the computing device determines the expansion of the samples about every 10 seconds.

14. The system for determining properties of asphalt as set forth in claim 9, wherein the computing device also determines a coefficient of thermal expansion of the asphalt.

15. The system for determining properties of asphalt as set forth in claim 14, wherein the coefficient of thermal expansion of the asphalt is determined as α(T)=dεₜₕ(T)/dT.
